(19) United States
(12) Patent Application Publication
(10) Pub. No.: US 2004/0145964 A1
(43) Pub. Date: Jul. 29, 2004

(54) Mixer bars cleaning in a radial or axial manner

(76) Inventors: Alfred Kunz, Witterswil (CH); Walther Schwenk, Kaiseraugst (CH); Joachim Wagner, Sisseln (CH)

Correspondence Address: BACHMAN & LAPOINTE, P.C., 900 CHAPEL STREET, SUITE 1201, NEW HAVEN, CT, 06510, US

(21) Appl. No.: 10/475,891

(22) PCT Filed: Apr. 12, 2002
(86) PCT No.: PCT/EP02/04099

(30) Foreign Application Priority Data
Apr. 25, 2001 (DE) 10120391.8
Dec. 10, 2001 (DE) 10160535.8
Jan. 22, 2002 (DE) 10202435.9

(51) Int. Cl. B01F 7/00

(52) U.S. Cl. 366/97; 366/301; 366/312

(57) ABSTRACT

The invention relates to a mixer-kneading device for carrying out mechanical, chemical and/or thermal processes, consisting of mixing elements (A, R) disposed on a shaft (2, 3), extending approximately in the longitudinal direction of the shaft (2, 3) or being somewhat inclined and comprising at least one scraping edge (14, 18, 21). Said mixer-kneading device is characterised in that clearance angles (w₁-w₆) are formed, respectively, in a direction leading away from the scraping edge (14, 18, 21) and which is opposite to the direction of movement of the mixer element.

The invention relates to a mixing kneader for carrying out mechanical, chemical and/or thermal processes with mixing elements on a shaft, which have scraping edges extending approximately in the longitudinal direction of the shaft or somewhat inclined.

Such mixing kneaders serve for a wide variety of different purposes. To be mentioned first is evaporation with solvent recovery, which is performed batchwise or continuously and often also under a vacuum. This is used for example for treating distillation residues and, in particular, toluene diisocyanates, but also production residues with toxic or high-boiling solvents from the chemical industry and pharmaceutical production, wash solutions and paint sludges, polymer solutions, elastomer solutions from solvent polymerization, adhesives and sealing compounds.

The apparatuses are also used for carrying out continuous or batchwise contact drying of water-moist and/or solvent-moist products, often likewise under a vacuum. Intended applications are in particular for pigments, dyes, fine chemicals, additives, such as salts, oxides, hydroxides, antioxidants, temperature-sensitive pharmaceutical and vitamin products, active substances, polymers, synthetic rubbers, polymer suspensions, latex, hydrogels, waxes, pesticides and residues from chemical or pharmaceutical production, such as salts, catalysts, slags, waste liquors. These processes also find applications in food production, for example in the production and/or treatment of block milk, sugar substitutes, starch derivatives, alginates, for the treatment of industrial sludges, oil sludges, bio sludges, paper sludges, paint sludges and generally for the treatment of tacky, crust-forming viscous-pasty products, waste products and cellulose derivatives.

In mixing kneaders, degassing and/or devolatilization can take place. This is applied to polymer melts, to spinning solutions for synthetic fibers and to polymer or elastomer granules or powders in the solid state.

In a mixing kneader, a polycondensation reaction can take place, usually continuously and usually in the melt, and is used in particular in the treatment of polyamides, polyesters, polyacetates, polyimides, thermoplastics, elastomers, silicones, urea resins, phenolic resins, detergents and fertilizers.

A polymerization reaction can also take place, likewise usually continuously. This is applied to polyacrylates, hydrogels, polyols, thermoplastic polymers, elastomers, syndiotactic polystyrene and polyacrylamides.

Quite generally, solid/liquid and multi-phase reactions can take place in the mixing kneader. This applies in particular to back-reactions, in the treatment of hydrofluoric acid, stearates, cyanates, polyphosphates, cyanuric acids, cellulose derivatives, cellulose esters, cellulose ethers, polyacetyl resins, sulfanilic acids, Cuphthalocyanines, starch derivatives, ammonium polyphosphates, sulfonates, pesticides and fertilizers.

Furthermore, solid/gas reactions can take place (for example carboxylation) or liquid/gas reactions can take place. This is applied in the treatment of acetates, azides, Kolbe-Schmitt reactions, for example BON, Na salicylates, parahydroxybenzoates and pharmaceutical products.

Liquid/liquid reactions take place in the case of neutralization reactions and transesterification reactions.

Dissolution and/or degassing takes place in such mixing kneaders in the case of spinning solutions for synthetic fibers, polyamides, polyesters and celluloses.

What is known as flushing takes place in the treatment or production of pigments.

A solid-state post-condensation takes place in the production or treatment of polyester and polyamides, a continuous slurrying, for example in the treatment of fibers, for example cellulose fibers, with solvents, crystallization from the melt or from solutions in the treatment of salts, fine chemicals, polyols, alkoxides, compounding, mixing (continuously and/or batchwise) in the case of polymer mixtures, silicone compounds, sealing compounds, fly ash, coagulation (in particular continuously) in the treatment of polymer suspensions.

In a mixing kneader, multi-functional processes can also be combined, for example heating, drying, melting, crystallizing, mixing, degassing, reacting - all of these continuously or batchwise. Substances which are produced or treated by this means are polymers, elastomers, inorganic products, residues, pharmaceutical products, food products, printing inks.

In mixing kneaders, vacuum sublimation/desublimation can also take place, whereby chemical precursors, for example anthraquinone, metal chlorides, organometallic compounds etc. are purified. Furthermore, pharmaceutical intermediates can be produced.

A continuous carrier-gas desublimation takes place, for example, in the case of organic intermediates, for example anthraquinone and fine chemicals.

Mixing kneaders may have one or two shafts, co-rotating or counter-rotating at the same or different speeds.

A mixing kneader of the type stated above is known for example from EP 0 517 068 B1. In it, two shafts extending axially parallel rotate in a counter-rotating or co-rotating manner in a mixer housing. In this case, mixing bars mounted on disk elements act with one another. Apart from the function of mixing, the mixing bars have the task of cleaning as well as possible surfaces of the mixer housing, of the shafts and of the disk elements that are in contact with product and of thereby avoiding unmixed zones. In particular in the case of highly compacting, hardening and crust-forming products, the ability of the mixing bars to reach the edges leads to high local mechanical loading of the mixing bars and of the shafts. These force peaks occur in particular when the mixing bars engage in those zones where the product finds it difficult to escape. Such zones are present, for example, where the disk elements are mounted on the shaft.

The present invention is based on the object of providing a mixing kneader of the type mentioned above in which the cleaning effect is maintained, but the loading of the mixing bars or the shafts is reduced.

It helps to achieve this object if clearance angles are formed respectively leading away from the scraping edges and counter to the direction of movement of the mixing element.

Clearance angles are understood as meaning that the respective scraping edge is adjoined by a surface with an angle opening with respect to the surface to be cleaned. The mixing element tapers as it were counter to the direction of movement.

The clearance angles extend in relation to the surfaces to be cleaned away from the latter. The clearance angle may in this case be 3° to 45°, preferably 10° to 20°. This has the effect of counteracting compaction of crusts and a brake drum effect.

The mixing elements may be mounted directly onto the shaft, but they are preferably arranged on the circumference of disk elements, which in turn are mounted onto the shafts. Coming into consideration in particular as mixing elements are forms of mixing or kneading bars, the scope of the invention covering all possible kneading bars, such as for example choppers, crust breakers, nippers, etc.

An additional advantage of the method arises from the fact that no compression zones occur in the area of engagement of the mixing bars of two shafts. This results in comminution or granulation of a pasty product mass (for example during drying or polymerization) without grinding effects, i.e. no fine fraction occurs. This is a particular advantage of the present invention.

Such mixing elements according to the invention are to be suitable for use in all known single-shaft or twin-shaft mixing kneaders co-rotating or counter-rotating at the same or different speeds, etc. The invention is not restricted in this sense.

In an exemplary embodiment, for which however protection is also sought independently, irrespective of the clearance angles, at least one mixing element of a ring is to have substantially only radially aligned scraping edges and the other mixing elements of a ring are to have substantially axially aligned scraping edges, or vice versa.

This means that the mixing bars or counter-elements of a ring share the task of cleaning, so that not every mixing bar cleans off both axially extending surfaces and radially extending surfaces. This has the effect of lowering the level of force which the shafts have to accept for the rotation and reducing the force peaks, while conversely not diminishing the cleaning effect.

As a further advantage of the different mixing bars on a ring or on an inside wall of the housing, differently formed mixing spaces are respectively obtained as a result in the area of engagement with the other mixing bars and lead to an additional mixing and dividing action on the products.

If two shafts are provided, the shafts preferably rotate at different speeds, which means that the mixing bars continually change track during rotation and so treatment of different areas takes place, in particular on the disk elements and the surfaces of the shafts. Added to this is the fact that the different speeds are preferably not in an integral ratio. The choice of a non-integral speed ratio has the effect that all the mixing bars of one shaft leave exactly the same engagement track on the other shaft, with a time delay, so that it is ensured that the other shaft is swept over completely even if individual mixing bars are omitted.

In a further preferred exemplary embodiment of the invention, neighboring rings on the same shaft and/or else intermeshing rings on shafts lying opposite each other or on the inside wall of the housing are to have a different number of mixing elements or counter-elements. This also allows the cleaning and kneading action to be varied.

The mixing elements or counter-elements may be mounted directly on the respective shaft or on the inside wall of the housing, but they are preferably arranged on the shaft on the circumference of disk elements. Coming into consideration in particular as mixing elements are forms of mixing or kneading bars, the scope of the invention covering all possible kneading bars, such as for example choppers, crust breakers, nippers, etc.

The individual scraping edges of the respective counter-bars or mixing bars and/or also the edges not required for cleaning may be provided with the aforementioned clearance angles, i.e. they extend in relation to the surfaces to be cleaned away from the latter. The clearance angle may in this case be 30 to 45°, preferably 10° to 20°. This has the effect of counteracting compaction of crusts and a brake drum effect.

An additional advantage of the method arises from the fact that no compression zones occur in the area of engagement of the mixing bars of the two shafts. This results in comminution or granulation of a pasty product mass (for example during drying or polymerization) without grinding effects, i.e. no fine fraction occurs. This is a particular advantage of the present invention.

Further advantages, features and details of the invention emerge from the description which follows of preferred exemplary embodiments and on the basis of the drawing, in which:

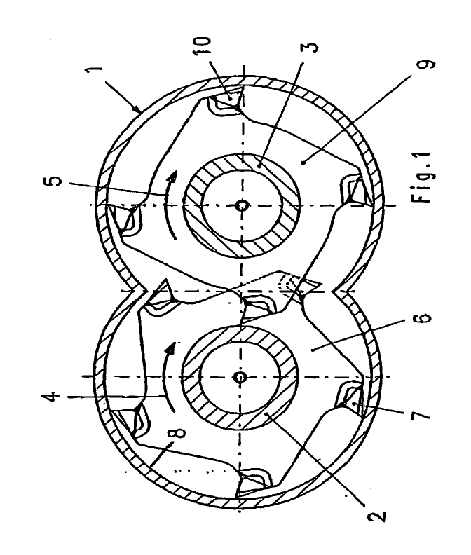

FIG. 1 shows a cross section through a mixing kneader according to the invention;

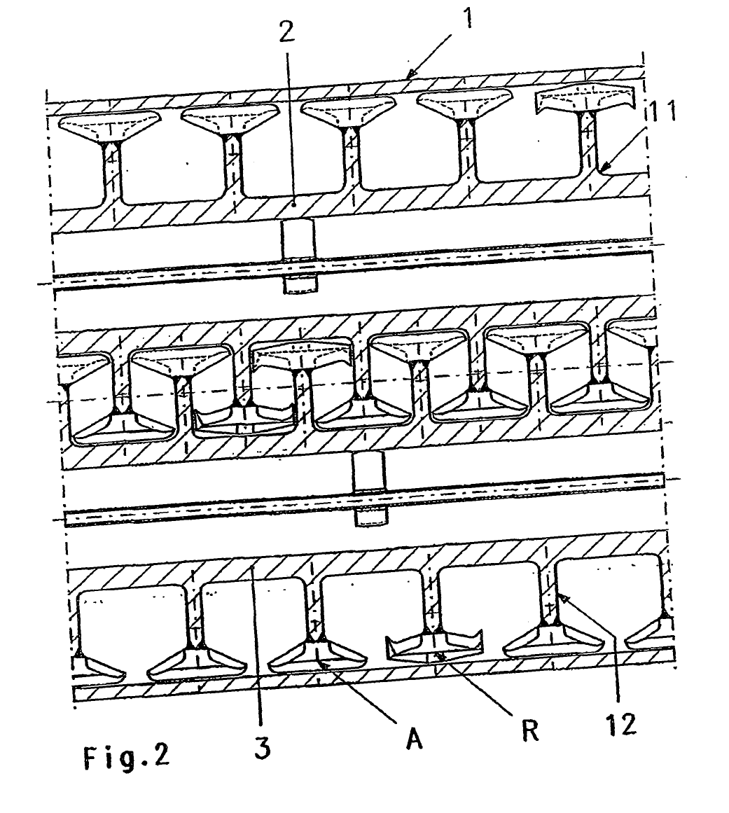

FIG. 2 shows part of a longitudinal section, shown enlarged, through the mixing kneader according to FIG. 1;

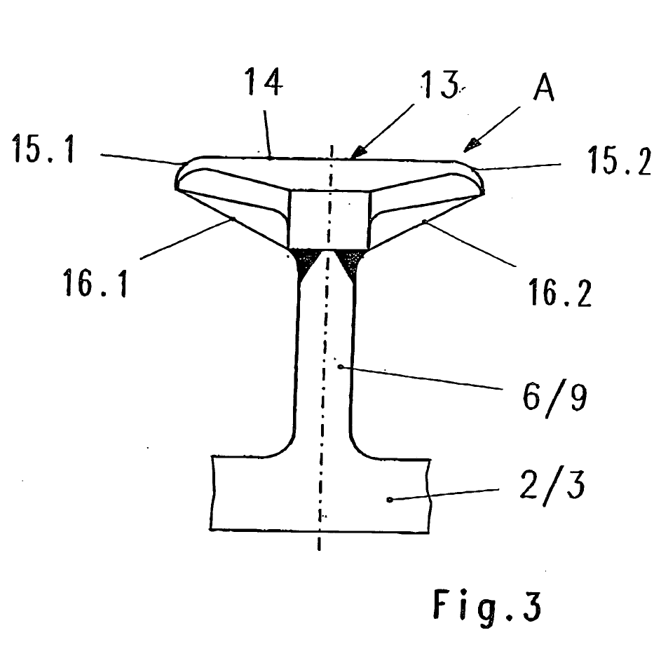

FIG. 3 shows a plan view of a mixing element according to the invention, arranged on a shaft;

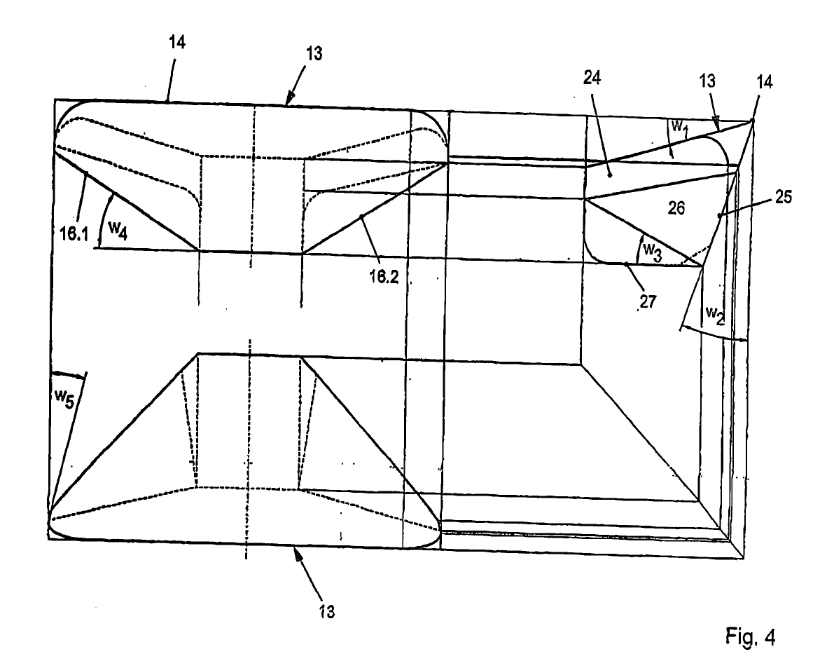

FIG. 4 shows three views of the mixing element as shown in FIG. 3 with corresponding reference lines;

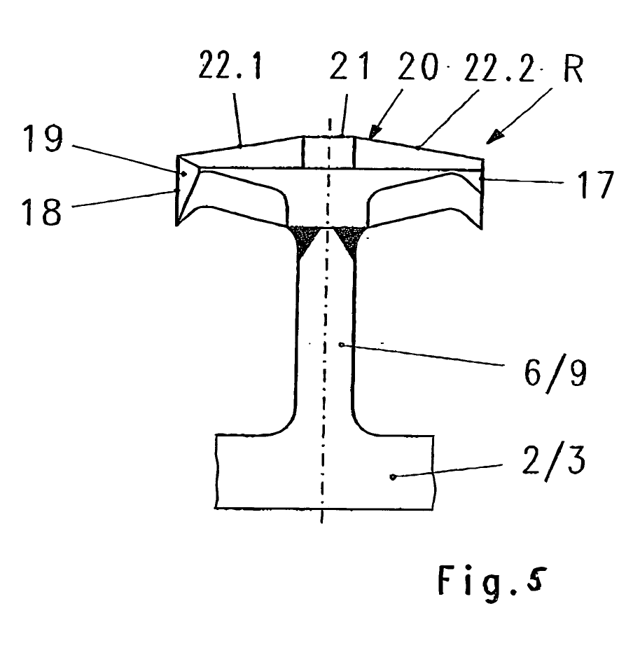

FIG. 5 shows a plan view of a further exemplary embodiment of a mixing element arranged on a shaft;

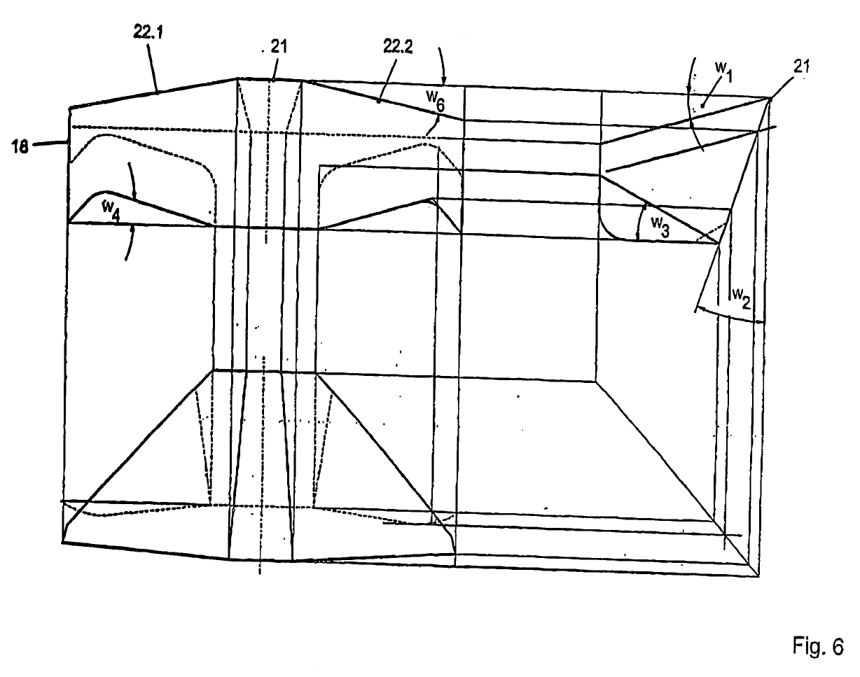

FIG. 6 shows three views of the mixing element as shown in FIG. 5 with corresponding reference lines;

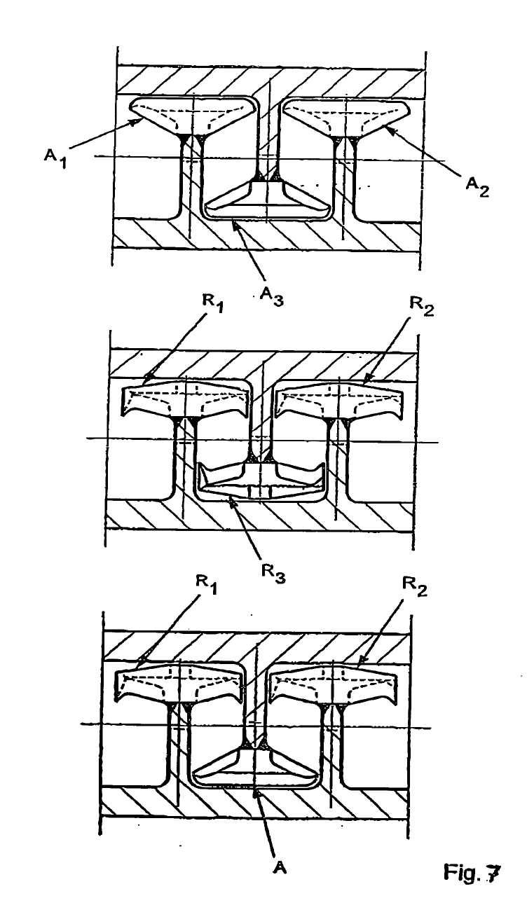

FIG. 7 shows three longitudinal sections through a mixing kneader according to the invention, which show the combination of different mixing elements.

According to FIG. 1, two shafts 2 and 3, which extend axially parallel to each other and are preferably heated, are located in a mixer housing 1. In this case, they co-rotate in a way corresponding to the arrows 4 and 5.

Seated on the shaft 2, spaced axially apart, are disk elements 6, on the circumference of which mixing elements 7 are arranged in a distributed manner. These mixing elements 7 move along an inside surface 8 of the mixer housing 1, at a small distance from it.

Also seated on the shaft 3, spaced axially apart, are disk elements 9, on the outer circumference of which mixing elements 10 are arranged in a distributed manner. It can be seen that on the disk elements 9 of the shaft 3 there are four mixing elements 10, while five mixing elements are assigned to the disk elements 6 of the shaft 2.

The mixing elements 10 also glide along near the inside surface 8 of the housing part assigned to the shaft 3. Furthermore, parts of the disk elements and mixing elements of the two shafts 2 and 3 engage in one another, i.e. they intermesh. The mixing elements are in this case arranged in such a way that they also respectively sweep along near the outer surface of the shaft 2 or 3 lying opposite.

As can be seen in FIGS. 1 and 2, four or five mixing elements 7 and 10, respectively, which are arranged in a plane around the respective shaft 2 or 3, form a ring 11 or 12, respectively. Each ring 11 or 12 can, considered by itself, be equipped with different mixing elements A and R. The mixing element R serves substantially for cleaning off radially extending surfaces, while the mixing element A is used with preference for cleaning off axially extending surfaces. Radially extending surfaces are, in particular, the surfaces of the disk elements 6 and 9. Axially extending surfaces are, in particular, the inside wall 8 of the housing and the outer surfaces of the shafts 2 and 3.

In FIG. 3, a mixing element A for the preferred cleaning off of axially extending surfaces is represented. It is mounted as mixing bar 13 on the disk element 6/9, which is connected to the shaft 2/3. Altogether, the mixing bar 13 is shaped approximately in a triangular form. It has a scraping edge 14, which extends axially in relation to the shaft 2/3. At both ends there are rounded-off corner regions 15.1 and 15.2, which merge with side flanks 16.1 and 16.2, which run toward each other.

Seen in section, the mixing bar 13 is also of a triangular construction, the mixing bar altogether tapering to the rear, counter to the direction of movement. Furthermore, the scraping edge 14 is inclined, so as to produce a clearance angle opening with respect to an inside surface 8 to be swept over or surface of the shaft 2 or 3 and directed counter to the direction of movement. As a result, no jamming of products to be treated takes place.

In FIG. 4, the mixing bar 13 is shown from three sides for better representation of the clearance angles, the contours of the mixing bar 13 being illustrated by corresponding reference lines.

In the representation, it can be seen at the top right that two clearance angles w₁ and w₂ extend away from the scraping edge 14. w₁ may preferably be 15°, w₂ preferably 20°.

With respect to the representation corresponding to FIG. 1, the clearance angle w₁ is formed between a tangent applied to the inside wall of the housing which extends through the scraping edge 14, while the clearance angle w₂ is formed with respect to a radial which extends between the scraping edge 14 and a shaft axis.

Between the corresponding surfaces 24 and 25 which respectively forms the clearance angles w₁ and w₂ with the tangent or radial there extends a further surface 26, which forms with a base 27 a third clearance angle W₃. This may be for example 25°. The base 27 extends approximately at right angles to the radial which extends through the center of the base 27.

The side flanks 16.1 and 16.2 also form a clearance angle W₄. The same applies to small lateral surfaces adjoining the scraping edge 14, which likewise form a clearance angle W₅.

The mixing element R for the preferred cleaning off of radially extending surfaces according to FIG. 5 is likewise mounted on a disk element 6/9 and this in turn is mounted on a shaft 2/3. This mixing element R is formed rather as a rhomboid and has two opposite, approximately radially extending edges 17 and 18. The edge 18 is formed as a scraping edge, which is followed counter to the direction of movement of the mixing element R or to the rear by a surface 19, which forms an undesignated clearance angle with respect to a disk surface to be swept over, for example. This configuration again produces for the mixing element R a triangular configuration in section.

An outer edge 20, assigned to the inside surface 8, is also shaped in such a way that only a small central part 21 sweeps past near the inside surface 8. On the other hand, the side parts 22.1 and 22.2 of the outer edge 20 that lead away from the central part 21 extend at an inclination or form a clearance angle w6 with respect to the inside surface 8.

The operating principle of the present invention is as follows:

During the operation of the mixing kneader, a product to be treated is introduced into the mixer housing 1 and treated by the shafts 2 and 3 rotating. As this happens, it can be transported in a direction of the housing from an inlet to an outlet. At least the shafts 2 and 3, or else the disk elements 6 and 9 too, are preferably controlled in their temperature.

The product is mixed and kneaded by the mixing elements 7 and 10. As this happens, shearing effects also take place in the proximity of interacting surfaces.

According to the invention, different mixing bars A and R are provided in a ring 11 or 12 of mixing elements 7 or 10, respectively. For example, in the case of the ring 11, four mixing bars A and only one mixing bar R may be provided. This means that only the mixing bar R cleans the radially extending surfaces, i.e. the disk surfaces, while the mixing bars A undertake the cleaning of the axially extending inside surfaces 8 and surfaces of the shaft. Accordingly, the level of force which the shafts 2 and 3 have to accept for the rotation is lowered significantly. Nevertheless, complete cleaning of all the radially and axially extending surfaces takes place, since the shafts rotate at different speeds, preferably with a non-integral speed ratio, so that the mixing bars change track with each revolution. As a result, the cleaning of the housing, of the shaft and of the disks on the shaft is shared between different mixing bars, so that there is a considerable reduction in the torque and the force peaks.

In FIG. 7 it can be seen that different possibilities may be provided for combining the mixing bars A and R. Three combinations are shown. In the first combination, a mixing bar A₃ passes through a mixing space which is formed by two mixing bars A₁ and A₂, which are likewise responsible for the cleaning off of axial surfaces.

The arrangement in the middle shows a mixing bar R₃ for cleaning off radially extending surfaces, which passes through a mixing space which is likewise formed by mixing bars R₁ and R₂ for cleaning off radially extending surfaces.

In the lower example, on the other hand, a mixing space is formed by two mixing bars R₁ and R₂ for cleaning off radially extending surfaces, and is swept over by a mixing bar A for cleaning off axially extending surfaces.

List of designations

| | | | | |
|---|---|---|---|---|
| 1 | mixer housing | 34 | 67 | |
| 2 | shaft | 35 | 68 | |
| 3 | shaft | 36 | 69 | |
| 4 | arrow | 37 | 70 | |
| 5 | arrow | 38 | 71 | |
| 6 | disk element | 39 | 72 | |
| 7 | mixing element | 40 | 73 | |
| 8 | inside surface | 41 | 74 | |
| 9 | disk element | 42 | 75 | |
| 10 | mixing element | 43 | 76 | |
| 11 | ring | 44 | 77 | |
| 12 | ring | 45 | 78 | |
| 13 | mixing bar | 46 | 79 | |
| 14 | scraping edge | 47 | | |
| 15 | corner region | 48 | A | axial mixing element |
| 16 | side flank | 49 | | |
| 17 | edge | 50 | | |
| 18 | scraping edge | 51 | | |
| 19 | surface | 52 | | |
| 20 | outside edge | 53 | | |
| 21 | central part | 54 | | |
| 22 | side part | 55 | | |
| 23 | | 56 | | |
| 24 | surface | 57 | | |
| 25 | surface | 58 | | |
| 26 | surface | 59 | R | radial mixing element |
| 27 | base | 60 | | |
| 28 | | 61 | | |
| 29 | | 62 | | |
| 30 | | 63 | | |
| 31 | | 64 | W | clearance angle |
| 32 | | 65 | | |
| 33 | | 66 | | |

Patent claims

1. A mixing kneader for carrying out mechanical, chemical and/or thermal processes with mixing elements (A, R) on a shaft (2, 3), which extend approximately in the longitudinal direction of the shaft (2, 3) or somewhat inclined and have at least one scraping edge (14, 18, 21), characterized
in that clearance angles (w₁- w₆) are formed respectively leading away from the scraping edge (14, 18, 21) and counter to the direction of movement of the mixing element.

2. A mixing kneader for carrying out mechanical, chemical and/or thermal processes with at least one rotating shaft (2, 3), mounted on which are mixing elements (7, 10, A, R) which interact with static and/or dynamic counter-elements, a number of mixing elements (7, 10, A, R) and/or counter-elements being combined to form axially spaced-apart rings (11, 12) on the shaft (2, 3) and/or on an inside wall of the housing, which mesh with one another, thereby cleaning off radially and axially aligned surfaces with scraping edges (14, 18), characterized in that at least one mixing element (R) of a ring (11, 12) has substantially only radially (18) aligned scraping edges and the other mixing elements (A) of a ring (12, 11) have substantially axially (14) aligned scraping edges, or vice versa.

3. The mixing kneader as claimed in claim 2, characterized in that the shafts (2, 3) rotate at different speeds.

4. The mixing kneader as claimed in claim 3, characterized in that the different speeds are not in an integral ratio.

5. The mixing kneader as claimed in one of claims 2 to 4, characterized in that the shafts (2, 3) co-rotate.

6. The mixing kneader as claimed in one of claims 2 to 5, characterized in that neighboring rings on the same shaft (2, 3) and/or else intermeshing rings (11, 12) on shafts lying opposite each other have a different number of mixing elements (7, 10).

7. The mixing kneader as claimed in at least one of claims 2 to 6, characterized in that the mixing element (7, 10) is mounted as bars on a circumference of a disk element (6, 9).

8. The mixing kneader as claimed in at least one of claims 1 to 7, characterized in that the edges (16.1, 16.2, 20) respectively not required for cleaning are provided with the clearance angles.

9. The mixing kneader as claimed in at least one of claims 1 to 8, characterized in that the mixing elements (A, R) taper to the rear, counter to their direction of movement, away from the scraping edges (14, 18) or have clearance angles with respect to surfaces to be cleaned.

10. The mixing kneader as claimed in at least one of claims 1 to 9, characterized in that the scraping edges (14, 18) are provided with a serration.

11. The mixing kneader as claimed in at least one of claims 1 to 10, characterized in that the clearance angles (w₁- w₆) are approximately 10°to 30°.

12. The mixing kneader as claimed in at least one of claims 1 to 11, characterized in that the mixing element (A) has a scraping edge (14) extending approximately in the longitudinal direction of the shaft (2, 3) or somewhat inclined, which forms two clearance angles (w₁, w₂) counter to the direction of movement of the mixing element (A).

13. The mixing kneader as claimed in claim 12, characterized in that the two clearance angles (w₁, w₂) away from the scraping edge (14) are assigned a third clearance angle (W₃), which at least partly joins the two others.

14. The mixing kneader as claimed in at least one of claims 1 to 13, characterized in that a scraping edge (18) extends approximately radially or somewhat inclined in relation to the shaft (2, 3) and forms a clearance angle counter to the direction of movement of the mixing element (R).

15. The mixing kneader as claimed in claim 14, characterized in that this clearance angle is assigned to the two other clearance angles (w₁, w₂) in a pyramid-like manner.
